(19) United States
(12) Patent Application Publication
(10) Pub. No.: US 2003/0178405 A1
(43) Pub. Date: Sep. 25, 2003

(54) Electrical heating assembly

(76) Inventor: Kevin Ronald McWilliams, Stratford upon Avon (GB)

Correspondence Address: Ira S. Dorman, Suite 200, 330 Roberts Street, East Hartford, CT, 06108, US

(21) Appl. No.: 10/385,921

(22) Filed: Mar. 11, 2003

(30) Foreign Application Priority Data
Mar. 15, 2002 (GB) 0206069.7

(51) Int. Cl. H05B 3/68

(52) U.S. Cl. 219/448.14; 219/448.17

(57) ABSTRACT

An electrical heating assembly (2) comprises a glass-ceramic cooking plate (4) having an upper surface (6) for receiving a cooking vessel (8) and a lower surface (10). A radiant electric heater (12) incorporating at least one electric heating element (20) is supported in contact with the lower surface of the cooking plate. A thick film temperature-sensitive electrical resistance element (30) is deposited on a region (32) of the lower surface (10) of the cooking plate (4) within the confines of the radiant electric heater (12) and is provided with electrical connecting leads (34). Thermal insulation means (40) is adapted and arranged to shield the thick film temperature-sensitive electrical resistance element (30) and at least the region (32) of the lower surface (10) of the cooking plate (4) on which it is deposited, from direct thermal radiation from the at least one electric heating element (20).

### FIELD OF THE INVENTION

This invention relates to an electrical heating assembly for a cooking appliance, in which a glass-ceramic cooking plate has an upper surface for receiving a cooking vessel and a lower surface having supported in contact therewith a radiant electric heater incorporating at least one electric heating element.

### BACKGROUND TO THE INVENTION

It is well known to provide such an electrical heating assembly for a cooking appliance in which a temperature sensing device is arranged under the glass-ceramic cooking plate in order to monitor the temperature of the glass-ceramic cooking plate and to operate to de-energise the one or more heating elements in the heater under the glass-ceramic cooking plate when a particular temperature is reached, in order to prevent thermal damage to the cooking plate.

Various forms of temperature sensing device have been proposed for this purpose. In particular, it has been proposed to provide a film-type sensor arranged on the lower surface of the glass-ceramic cooking plate within confines of the radiant electric heater. Such a sensor in this location is exposed to direct thermal radiation from the one or more heating elements of the heater and must be able to withstand very high temperatures reached by the glass-ceramic cooking plate, such temperatures being of the order of 700 degrees Celsius. Consequently, special materials are required for the sensor and no cost-effective solution has yet been found.

Requirements exist for sensing the temperature of a cooking vessel located on the upper surface of the glass-ceramic cooking plate, using a temperature sensing device provided underneath the cooking plate. A problem is encountered in that the high temperature of the glass-ceramic cooking plate between the sensing device and the cooking vessel influences the measurement. If the temperature of the glass-ceramic in this region is too high, this prevents any sensing of a lower temperature of the overlying cooking vessel. Furthermore, the high temperature effect on the sensing device of direct thermal radiation from the one or more heating elements in the underlying radiant heater also prevents the sensing device from sensing the temperature of the cooking vessel.

It is known to provide what is referred to as a ‘cool patch’ of the glass-ceramic cooking plate within a heated area by an arrangement in which a discrete temperature sensing device surrounded by a thermally insulating enclosure is urged directly against a region of the lower surface of the glass-ceramic cooking plate, to sense a change in temperature of the cooking plate produced by an overlying cooking vessel conducting heat back into the cooking plate in that area. Such a discrete temperature sensing device has been provided of capillary or electromechanical form, or of platinum resistance temperature detector form, urged against the lower surface of the glass-ceramic cooking plate such as by spring loading means. Such an arrangement is bulky and expensive to implement.

### OBJECT OF THE INVENTION

It is an object of the present invention to overcome or minimise this problem.

### SUMMARY OF THE INVENTION

According to the present invention there is provided an electrical heating assembly comprising:

a glass-ceramic cooking plate having an upper surface for receiving a cooking vessel and a lower surface;

a radiant electric heater incorporating at least one electric heating element, the heater being supported in contact with the lower surface of the cooking plate;

a thick film temperature-sensitive electrical resistance element deposited on a region of the lower surface of the cooking plate within the confines of the radiant electric heater and provided with electrical connecting leads; and

thermal insulation means adapted and arranged to shield the thick film temperature-sensitive electrical resistance element and at least a region of the lower surface of the cooking plate on which it is deposited, from direct thermal radiation from the at least one electric heating element.

The thermal insulation means may also be arranged to shield the electrical connecting leads from the direct thermal radiation from the at least one electric heating element.

The electrical connecting leads may be arranged for electrical connection to circuit means. The circuit means may be adapted to monitor electrical resistance of the thick film temperature-sensitive electrical resistance element as a function of temperature of the shielded region of the lower surface of the cooking plate on which it is deposited and hence as a function substantially of temperature of a cooking vessel located on the upper surface of the cooking plate and overlying such shielded region.

The electrical connecting leads may be arranged to extend from the thick film temperature-sensitive electrical resistance element at least to a peripheral region of the radiant electric heater.

The electrical connecting leads may be of thick film form and may be deposited on the lower surface of the glass-ceramic cooking plate.

The electrical connecting leads and optionally the thick film temperature-sensitive electrical resistance element, may be screen-printed and fired onto the lower surface of the glass-ceramic cooking plate.

The thick film temperature-sensitive electrical resistance element and/or the electrical connecting leads may comprise an electrically conductive phase selected from platinum, gold, silver, palladium, nickel and alloys thereof.

The thermal insulation means may extend between a lower surface of the glass-ceramic cooking plate and the at least one electric heating element and may be dimensioned so as to provide an air space between a lower surface of the thermal insulation means and the at least one electric heating element.

The thermal insulation means may be selected from pad and block form and may be in contact with the lower surface of the glass-ceramic cooking plate. The thermal insulation means may be provided with a shallow recess for accommodating the thick-film temperature-sensitive electrical resistance element and, optionally, the electrical leads.

The thermal insulation means may be secured to, or held in contact with, the lower surface of the glass-ceramic cooking plate.

The thermal insulation means may be selected from vermiculite, microporous, ceramic fibre and calcium silicate materials.

The thermal insulation means may have an external surface provided with a layer of thermal radiation-reflecting material.

The radiant electric heater may comprise a dish-like support accommodating the at least one electric heating element and having a peripheral wall of thermal insulation material contacting the lower surface of the glass-ceramic cooking plate.

If desired, an electrically insulating or passivation layer, such as of thick film form, may be provided between the lower surface of the glass-ceramic cooking plate and the thick film temperature-sensitive electrical resistance element.

A temperature-responsive means may additionally be provided to sense temperature of a region of the glass-ceramic cooking plate subjected to direct thermal radiation from the at least one electric heating element of the radiant electric heater and adapted to de-energise the at least one electric heating element when a predetermined maximum operating temperature is reached by the cooking plate.

By means of the present invention a region is provided on the cooking plate in the form of a relatively cool patch having a lower temperature than the surrounding regions of the glass-ceramic cooking plate. The temperature of this cool patch region is monitored by the thick film temperature-sensitive electrical resistance element deposited on the lower surface of the cooking plate in this region. Heat from an overlying cooking vessel is conducted into this region of the cooking plate and the thick film element is therefore able to monitor the temperature of the cooking vessel and provide temperature control in a cooking function known in the art as an autocook function.

Because the thick film temperature-sensitive element is deposited on this cooler region of the cooking plate and is not subjected to direct radiation from the at least one electric heating element, the materials from which the thick film element is constructed need not have a very high temperature-withstanding capability and can consequently be relatively inexpensive.

For a better understanding of the present invention and to show more clearly how it may be carried into effect, reference will now be made, by way of example, to the accompanying drawings in which:

### BRIEF DESCRIPTION OF THE DRAWINGS

FIG. 1 is a top plan view of an embodiment of an electrical heating assembly according to the present invention; and

FIG. 2 is a cross-sectional view of the assembly of FIG. 1.

### DESCRIPTION OF PREFERRED EMBODIMENT

Referring to the drawings, an electrical heating assembly 2 comprises a glass-ceramic cooking plate 4 of well-known form, having an upper surface 6 for receiving a cooking vessel 8. A lower surface 10 of the cooking plate 4 has a radiant electric heater 12 supported in contact therewith. The radiant electric heater 12 comprises a metal dish-like support 14 in which is provided a base layer 16 of thermal and electrical insulation material, such as microporous thermal and electrical insulation material. A peripheral wall 18 of thermal insulation material is arranged to contact the lower surface 10 of the cooking plate 4.

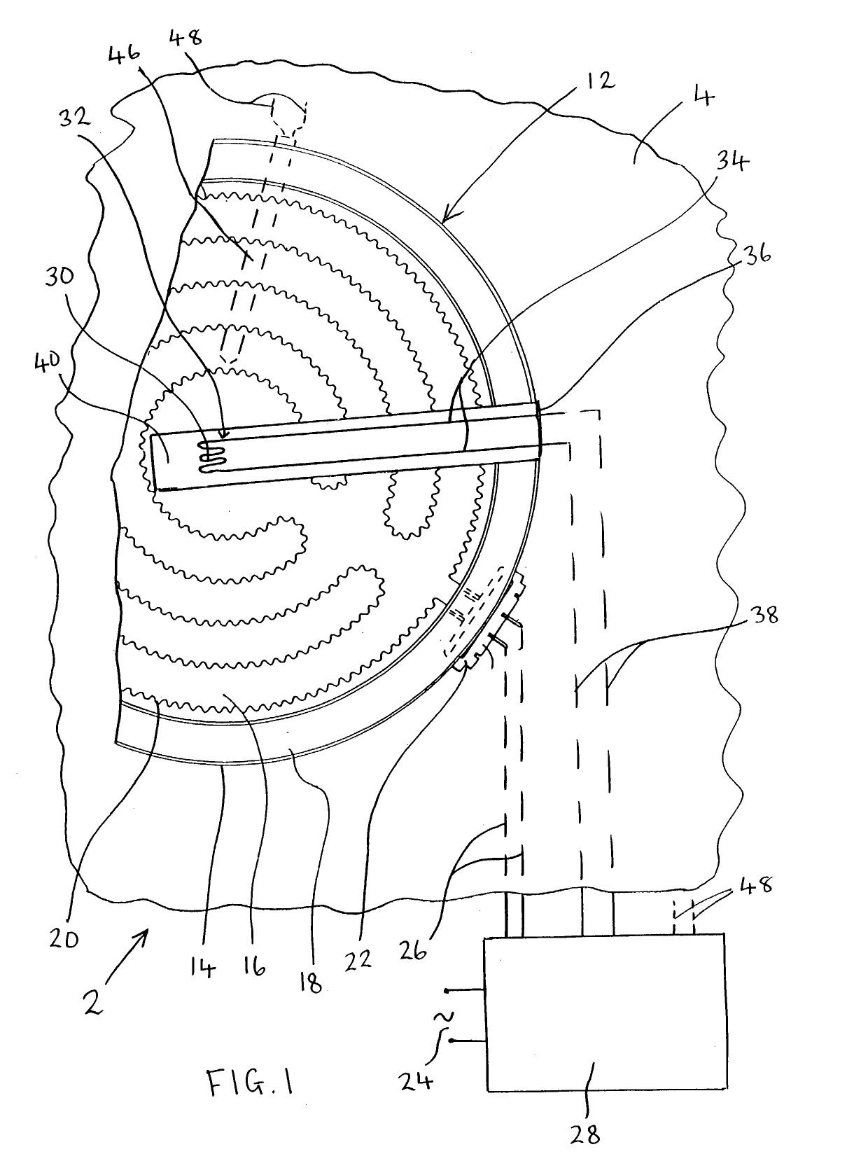

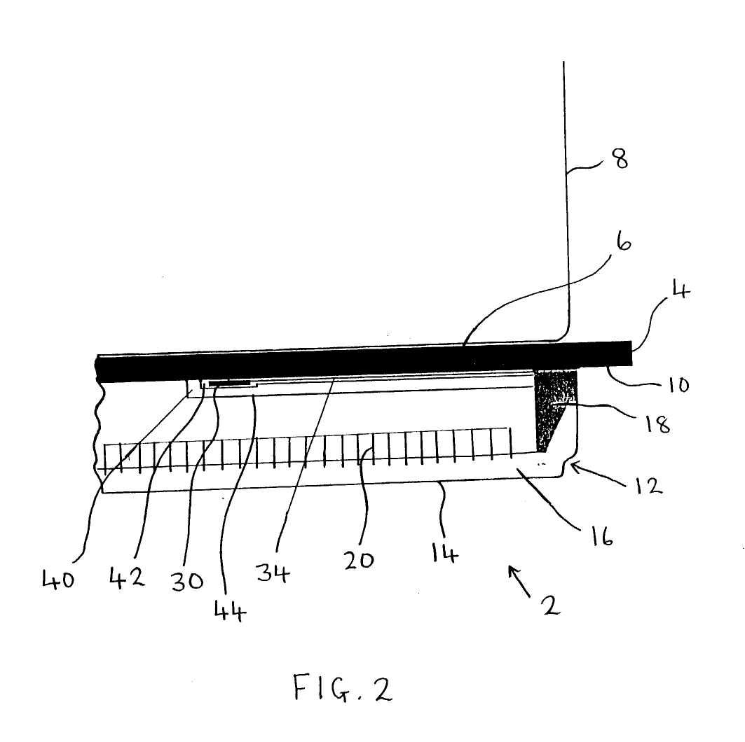

At least one radiant electric heating element 20 is supported relative to the base layer 16. The heating element or elements 20 can comprise any of the well-known forms of heating element, such as wire, ribbon, foil or lamp forms, or combinations thereof. As particularly shown in FIGS. 1 and 2, the heating element or elements 20 can be of corrugated ribbon form, supported edgewise on the base layer 16 of insulation material.

A terminal block 22 is provided at an edge region of the heater 12, for connecting the heating element or elements 20 to a power supply 24 by way of leads 26 and through a control means 28, which may be a microprocessor-based control arrangement.

The cooking vessel 8 is heated by means of direct thermal radiation from the heating element or elements 20 on the cooking plate 4 and as a result of which the cooking plate may reach temperatures as high as 700 degrees Celsius.

For many cooking operations, such as frying, it is required to provide what is commonly referred to as an autocook facility in which the actual temperature of the cooking vessel 8 is monitored and the heater 12 is appropriately controlled. In the present invention this is achieved by depositing a thick film temperature-sensitive electrical resistance element 30 on a region 32 of the lower surface 10 of the glass-ceramic cooking plate 4, within confines of the radiant electric heater 12 and such that the cooking vessel 8 overlies the thick film element 30. The thick film element 30 is provided with electrical connecting leads 34, which may also be of thick film form deposited on the lower surface 10 of the cooking plate 4. Such electrical connecting leads 34 are arranged to extend at least to a peripheral region 36 of the heater 12. The connecting leads 34 are further connected by leads 38 to the control means 28. Such leads 38 may be of discrete form, or may include at least portions thereof of film form, such as thick film form, deposited on the lower surface 10 of the cooking plate 4.

If desired, an electrically insulating or passivation layer (not shown), such as of thick film form, may be provided on the lower surface 10 of the cooking plate 4 and on which the thick film element 30 is deposited. The connecting leads 34 may also be deposited on such an electrically insulating layer.

In order to shield the region 32 of the glass-ceramic cooking plate 4 from direct thermal radiation from the heating element or elements 20, a block or pad 40 of thermal insulation material is arranged in contact with the lower surface 10 of the cooking plate 4. The block or pad 40 is arranged to cover the thick film temperature-sensitive element 30 and also the connecting leads 34 and may be provided with a shallow recess 42 for accommodating the thick film element 30 and the connecting leads 34. The block or pad 40 is relatively thin, about 5 mm, and is spaced above the heating element or elements 20 so as to provide an air gap between the heating element or elements and the underside of the block or pad 40. In this way the block or pad does not affect the heat output of the heating element or elements. Thus, the block or pad 40 is also spaced above the base layer 16 of thermal and electrical insulation material. The block or pad 40 may comprise any thermal insulation material capable of withstanding the high temperatures encountered inside the heater 12. Examples of suitable thermal insulation materials are vermiculite, microporous, ceramic fibre and calcium silicate materials. The block or pad 40 may also be provided on its external surface 44 with a layer of thermal radiation-reflecting material. The block or pad 40 may be secured in contact with the lower surface 10 of the cooking plate 4 by means of a suitable high-temperature-withstanding adhesive material, or may be held in contact with the lower surface 10 of the cooking plate 4 by being clamped at an end region thereof between the peripheral wall 18 of the heater 12 and the lower surface 10 of the cooking plate 4.

The thick film temperature-sensitive electrical resistance element 30 and the connecting leads 34 are suitably screen-printed and fired onto the lower surface 10 of the cooking plate 4. The thick film element 30 and connecting leads 34 are subjected to relatively low temperatures because they are shielded from direct radiation from the heating element or elements 20 by the block or pad 40 of thermal insulation material. Relatively inexpensive thick film materials can therefore be employed for the element 30 and connecting leads 34, although a wide range of materials could be selected. Suitable thick film materials may comprise an electrically conductive phase selected, for example, from platinum, gold, silver, palladium and nickel and alloys thereof. The electrically conductive phase must, of course, provide an electrical resistance which changes satisfactorily as a function of temperature.

The block or pad 40 results in a relatively cool patch in the region 32 of the glass-ceramic cooking plate 4. Heat from the heated cooking vessel 8 is therefore able to be conducted through this region 32 of the cooking plate and the thick film temperature-sensitive electrical resistance element 30 senses changes in temperature in this region 32. Accordingly, the thick film element 30 is able to monitor the temperature of the cooking vessel 8 and to appropriately control energising of the heating element or elements 20 by way of the control means 28.

A well-known form of temperature-responsive means 46 is suitably additionally provided in the heater 12 and connected by lead wires 48 to the control means 28. Such temperature-responsive means 46 is arranged to sense the temperature of a region of the glass-ceramic cooking plate 4 subjected to direct thermal radiation from the heating element or elements 20 and to de-energise the heating element or elements 20 when a predetermined maximum operating temperature is reached by the cooking plate 4, thereby preventing thermal damage to the material of the cooking plate 4.

I claim:

1. An electrical heating assembly comprising:
a glass-ceramic cooking plate having an upper surface for receiving a cooking vessel and a lower surface;
a radiant electric heater incorporating at least one electric heating element, the heater being supported in contact with the lower surface of the cooking plate;
a thick film temperature-sensitive electrical resistance element deposited on a region of the lower surface of the cooking plate within the confines of the radiant electric heater and provided with electrical connecting leads; and
thermal insulation means adapted and arranged to shield the thick-film temperature-sensitive electrical resistance element and at least a region of the lower surface of the cooking plate on which it is deposited, from direct thermal radiation from the at least one electric heating element.

2. An assembly according to claim 1, wherein the thermal insulation means is also arranged to shield the electrical connecting leads from the direct thermal radiation from the at least one electric heating element.

3. An assembly according to claim 1, wherein the electrical connecting leads are arranged for electrical connection to circuit means.

4. An assembly according to claim 3, wherein the circuit means is adapted to monitor the electrical resistance of the thick film temperature-sensitive electrical resistance element as a function of temperature of the shielded region of the lower surface of the cooking plate on which it is deposited and hence as a function substantially of temperature of a cooking vessel located on the upper surface of the cooking plate and overlying such shielded region.

5. An assembly according to claim 1, wherein the electrical connecting leads are arranged to extend from the thick film temperature-sensitive electrical resistance element at least to a peripheral region of the radiant electric heater.

6. An assembly according to claim 1, wherein the electrical connecting leads are of thick film form.

7. An assembly according to claim 6, wherein the electrical connecting leads are deposited on the lower surface of the glass-ceramic cooking plate.

8. An assembly according to claim 6, wherein the electrical connecting leads are screen-printed and fired onto the lower surface of the glass-ceramic cooking plate.

9. An assembly according to claim 1, wherein the thick film temperature-sensitive electrical resistance element is screen-printed and fired onto the lower surface of the glass-ceramic cooking plate.

10. An assembly according to claim 1, wherein the thick film temperature-sensitive electrical resistance element and/or the electrical connecting leads comprise(s) an electrically conductive phase selected from platinum, gold, silver, palladium, nickel and alloys thereof.

11. An assembly according to claim 1, wherein the thermal insulation means extends between the lower surface of the glass-ceramic cooking plate and the at least one electric heating element and is dimensioned so as to provide an air space between a lower surface of the thermal insulation means and the at least one electric heating element.

12. An assembly according to claim 1, wherein the thermal insulation means is selected from pad and block form and is in contact with the lower surface of the glass-ceramic cooking plate.

13. An assembly according to claim 12, wherein the thermal insulation means is provided with a shallow recess for accommodating the thick film temperature-sensitive electrical resistance element.

14. An assembly according to claim 1, wherein the thermal insulation means is secured to the lower surface of the glass-ceramic cooking plate.

15. An assembly according to claim 1, wherein the thermal insulation means is held in contact with the lower surface of the glass-ceramic cooking plate.

16. An assembly according to claim 1, wherein the thermal insulation means is selected from vermiculite, microporous, ceramic fibre and calcium silicate materials.

17. An assembly according to claim 1, wherein the thermal insulation means has an external surface provided with a layer of thermal radiation-reflecting material.

18. An assembly according to claim 1, wherein the radiant electric heater comprises a dish-like support accommodating the at least one electric heating element and having a peripheral wall of thermal insulation material contacting the lower surface of the glass-ceramic cooking plate.

19. An assembly according to claim 1, wherein an electrically insulating (passivation) layer is provided between the lower surface of the glass-ceramic cooking plate and the thick film temperature-sensitive electrical resistance element.

20. An assembly according to claim 19, wherein the electrically insulating layer is of thick film form.

21. An assembly according to claim 1, wherein a temperature-responsive means is additionally provided to sense temperature of a region of the glass-ceramic cooking plate subjected to direct thermal radiation from the at least one electric heating element and adapted to de-energise the at least one electric heating element when a predetermined maximum operating temperature is reached by the cooking plate.
